(19) United States
(12) Patent Application Publication
(10) Pub. No.: US 2003/0021299 A1
(43) Pub. Date: Jan. 30, 2003

(54) Multiplexer and demultiplexer

(76) Inventor: Takeshi Ota, Tokyo (JP)

Correspondence Address: NOTARO AND MICHALOS, 100 DUTCH HILL ROAD, SUITE 110, ORANGEBURG, NY, 10962-2100, US

(21) Appl. No.: 10/174,703

(22) Filed: Jun. 19, 2002

(30) Foreign Application Priority Data
Jun. 22, 2001 (JP) 2001-189084

(51) Int. Cl. H04J 3/04

(52) U.S. Cl. 370/535

(57) ABSTRACT

A word alignment mechanism of a series-parallel converter is kept away from errors when multiplexing Gigabit Ethernet signals. The errors result from K28.5 codes in the low-order 10 bits of the Gigabit Ethernet signals. The clock rates of two Gigabit Ethernet signals are adjusted by transmitting each signal via an optical transceiver, a series-parallel converter, and an elastic smoother. The K28.5 codes of only the highest order Gigabit Ethernet signal are preserved, while the K28.5 codes for all other signals are converted to different codes using a code swapper and supplied to the series-parallel converter, which outputs a multiplexed signal. When recovering the original signals from the multiplexed signal, the different codes are converted back to the K28.5 codes.

### FILED OF THE INVENTION

The present invention relates to a multiplexer and a demultiplexer, and particularly to a multiplexer and a demultiplexer for multiplexing and demultiplexing signals encoded according to the 8B/10B encoding scheme.

### DESCRIPTION OF THE RELATED ART

In conventional SONET/SDH, low-speed signals such as OC-3 signals (155.5 Mbps) are transmitted after multiplexing four OC-3 signals to form an OC-12 signal (622 Mbps). Such multiplexing can reduce transmission costs.

In recent years, Gigabit Ethernet has rapidly become popular. Unlike SONET/SDH, Gigabit Ethernet handles signals using the 8B/10B encoding scheme. Further, it has not been possible to multiplex Gigabit Ethernet signals using a series-parallel converter since clock synchronization between devices is not performed.

Next, FIGS. 6-8 will be used to illustrate problems that can be envisioned when trying to multiplex Gigabit Ethernet signals with a series-parallel converter. As shown in FIG. 6, a multiplexer 101a (multiplexer/demultiplexer) combines Gigabit Ethernet signals 103a and 104a and outputs a multiplexed signal 108 on an optical fiber 102. A multiplexer 101b (multiplexer/demultiplexer) converts the multiplexed signal 108 back into two Gigabit Ethernet signals 103b and 104b.

FIG. 7 is a block diagram showing the internal construction of the multiplexer 101a. The multiplexer 101a is configured of optical transceivers 111 and 112 having a transmission rate of 1.25 Gbps, such as the SDM7104 manufactured by Sumitomo Electric Industries, Ltd.; 10-bit series-parallel converters 113 and 114, such as the VSC 7135 manufactured by Vitesse Semiconductor Corporation; a 20-bit series-parallel converter 118, such as the VSC 7146 also manufactured by Vitesse; and an optical transceiver 119 having a transmission rate of 2.5 Gbps, such as the SDM7128 manufactured by Sumitomo Electric Industries. One might think that multiplexing is possible by driving the 20-bit series-parallel converter 118 at twice the clock speed for driving the Gigabit Ethernet signal 103a.

However, since clock synchronization is not conducted between devices in Gigabit Ethernet, a maximum clock speed differential of 200 ppm is produced between the Gigabit Ethernet signals 103a and 104a. Consequently, even when the clock for driving the series-parallel converter 118 is generated based on either the Gigabit Ethernet signal 103a or 104a, a word unit of the signal having the slower clock rate will eventually be lost.

In 8B/10B encoding, a special 10-bit code called a K28.5 signal is used to perform word alignment. That design can lead to loss of lock. When the series-parallel converter 118 detects a 10-bit K28.5 signal, the series-parallel converter 118 performs word alignment by locating this signal in the high-order 10 bits. Both the Gigabit Ethernet signals 103a and 104a contain this K28.5 signal. FIG. 8(a) shows the Gigabit Ethernet signal 103a, while FIG. 8(b) shows the Gigabit Ethernet signal 104a. As shown in FIG. 8(c), the Gigabit Ethernet signal 103a is supplied to the high-order 10 bits of the series-parallel converter 118, while the Gigabit Ethernet signal 104a is supplied to the low-order 10 bits. Since the series-parallel converter 118 performs word alignment mechanically, locating the K28.5 singal into the high-order 10 bits, an error is generated in response to the K28.5 signal in the Gigabit Ethernet signal 104a allocated in the low-order 10 bits.

### DISCLOSURE OF THE INVENTION

In view of the foregoing problem of clock speed differential generated when multiplexing Gigabit Ethernet signals and the error in word alignment generated by the K28.5 code contained in the low-order 10 bits, it is an object of the present invention to provide a multiplexer/demultiplexer capable of multiplexing Gigabit Ethernet signals using the 8B/10B encoding scheme with a series-parallel converter. The present invention can also be applied to the multiplexing of other signals employing the 8B/10B encoding scheme.

These objects and others will be attained by a multiplexer/demultiplexer according to the present invention having the configuration described in the attached claims. Here, we will provide a supplementary description of the claims prior to describing the present invention in greater detail.

According to one aspect of the present invention, a multiplexer that multiplexes a plurality of signal streams encoded according to an 8B/10B encoding scheme comprises a mechanisms of preserving the word alignment code in one signal stream of the plurality of signal streams, converting word alignment codes in all other signal streams of the plurality of signal streams to different codes, and transmitting a resulting multiplexed signal.

Only the word alignment codes for one specific signal stream among the plurality of signal streams are preserved, while the word alignment codes included in all other signal streams are converted to different codes. Accordingly, with this method it is possible to prevent the series-parallel converter from losing lock. Further, by providing the multiplexer with an elastic smoother, clock speed differences between Gigabit Ethernet signals are absorbed.

The multiplexer can be configured in one unit comprising a multiplexing mechanism and a demultiplexing mechanism or as a separate multiplexer and demultiplexer.

These aspects of the present invention and others defined in the scope of the claims will be described in more detail in the accompanying embodiments.

### BRIEF DESCRIPTION OF THE DRAWINGS

In the drawings:

FIG. 1 is a block diagram showing the preferred embodiment of the present invention;

FIG. 2 is a block diagram showing the internal construction of a multiplexer according to the present invention;

FIG. 3 is an explanatory diagram showing the behavior during transmission of the multiplexers according to the present invention;

FIG. 4 is an explanatory diagram showing the behavior during reception of the multiplexers according to the present invention;

FIG. 5 is a block diagram showing the construction of an elastic smoother provided in the multiplexer of the present invention;

FIG. 6 is a block diagram showing multiplexers of the prior art;

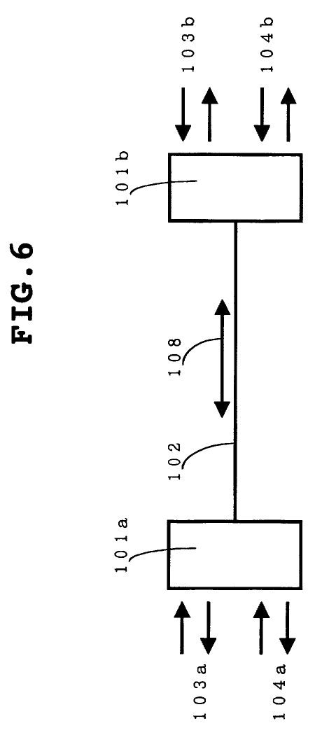

FIG. 7 is a block diagram showing the internal construction of a multiplexer according to the prior art; and

FIG. 8 is an explanatory diagram illustrating how the problem of losing lock occurs in multiplexers of the prior art.

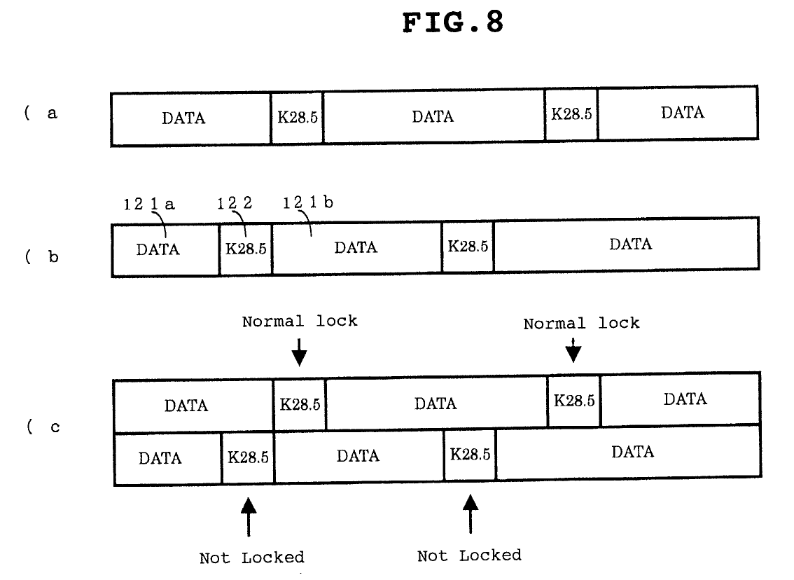

### BEST MODE FOR CARRYING OUT INVENTION

A multiplexer according to a preferred embodiment of the present invention will be described while referring to the accompanying drawings.

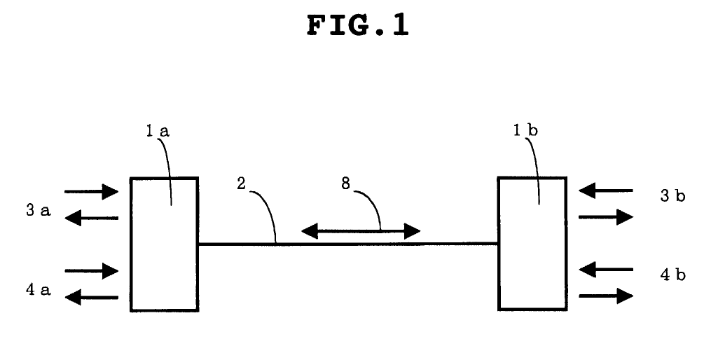

FIG. 1 shows an example of the preferred embodiment with a multiplexer 1a and a multiplexer 1b. The multiplexer 1a multiplexes Gigabit Ethernet signals 3a and 4a to form a multiplexed signal 8. The multiplexer 1a transmits the multiplexed signal 8 on an optical fiber 2. The multiplexer 1b receives the multiplexed signal 8 and converts the multiplexed signal 8 back to two Gigabit Ethernet signals 3b and 4b. Similarly, the multiplexer 1b multiplexes the Gigabit Ethernet signals 3b and 4b to form the multiplexed signal 8, and the multiplexed signal 8 is restored to the Gigabit Ethernet signals 3a and 4a by the multiplexer 1a.

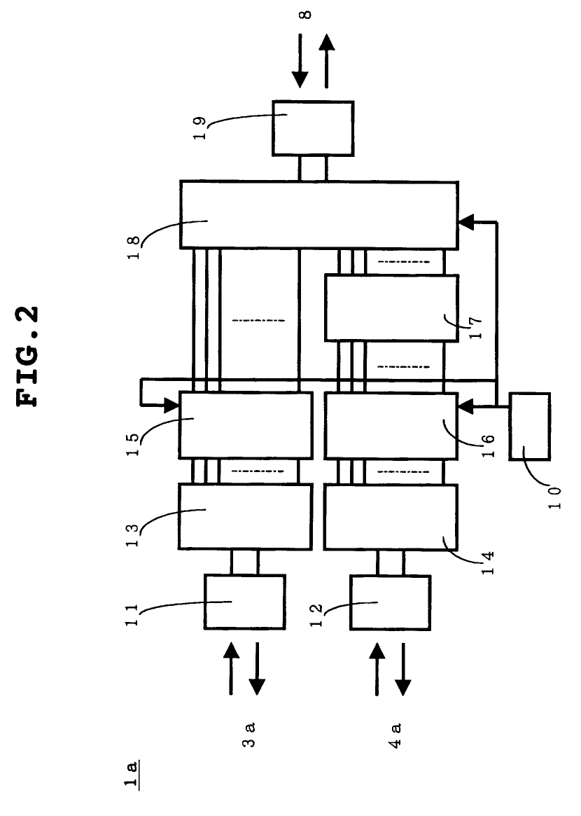

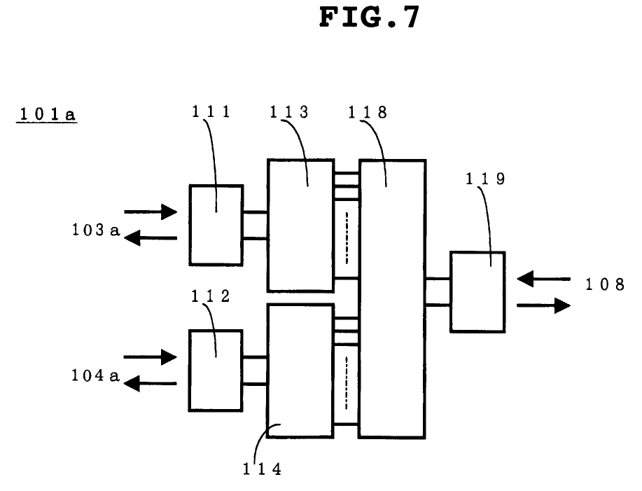

FIG. 2 shows the internal construction of the multiplexer 1a. The multiplexer 1a comprises optical transceivers 11 and 12 having a transmission rate of 1.25 Gbps, such as the SDM7104 manufactured by Sumitomo Electric Industries, Ltd.; 10-bit series-parallel converters 13 and 14, such as the VSC 7135 manufactured by Vitesse Semiconductor Corporation; elastic smoothers 15 and 16; a code swapper 17 provided for the low-order 10 bits; a clock generator 10; a 20-bit series-parallel converter 18, such as the VSC 7146 manufactured by Vitesse; and an optical transceiver 19 having a transmission rate of 2.5 Gbps, such as the SDM7128 manufactured by Sumitomo Electric Industries. The primary differences from the conventional configuration shown in FIG. 7 is that the multiplexer 1a of FIG. 2 is provided with the elastic smoothers 15 and 16 and the code swapper 17 for the low-order 10 bits. The elastic smoothers 15 and 16 are mechanisms for removing clock speed differential between devices by adjusting the length of idle signals in the Gigabit Ethernet signal. By providing the elastic smoothers 15 and 16, the multiplexing device of the present invention solves the problem of drive clock speed differential between devices, one of the two problems mentioned above. The clock generated by the clock generator 10 drives three devices: the elastic smoothers 15 and 16, and the 20-bit series-parallel converter 18.

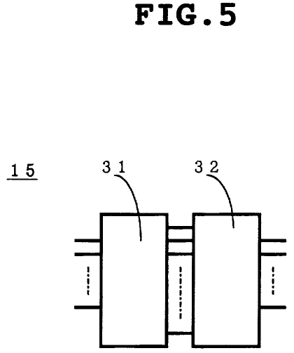

As shown in FIG. 5, the elastic smoother 15 is configured of a combination of media access controller chips 31 and 32 for Gigabit Ethernet, such as the VSC 8840 manufactured by Vitesse. The controller chips 31 and 32 include a 32-bit PCI bus interface and a 10-bit FC0 interface and are connected to each other via the PCI interface. The elastic smoothers have a function for adjusting the length of idle signals that are transmitted between valid data signals, thereby absorbing the differential in drive clock speeds between two Gigabit Ethernets.

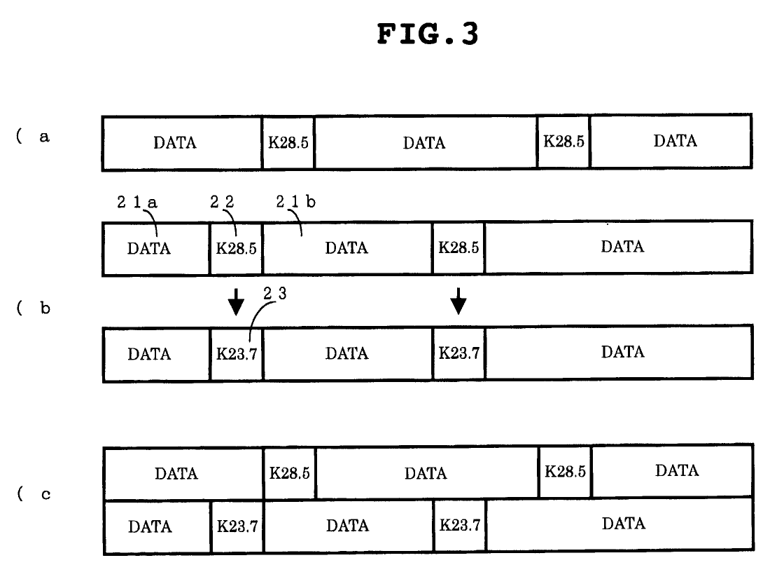

The code swapper 17 has a function for converting K28.5 signals 22 shown in FIG. 3(b) to an other K code K23.7 signals 23 during transmission. FIG. 3 illustrates the following three data constructions, described in order. FIG. 3(a) shows the Gigabit Ethernet signal 3a. FIG. 3(b) shows the Gigabit Ethernet signal 4a. FIG. 3(c) shows both the Gigabit Ethernet signals 3a and 4a after they have been combined in the 20-bit series-parallel converter 18. Since the K28.5 signals 22 in the low-order 10 bits have been converted to the K23.7 signals 23 in the present embodiment, no errors in word alignment occur. While the K28.5 signals are converted to K23.7 signals in the present embodiment, any other K codes (comma character) not involved in the word alignment can also be used.

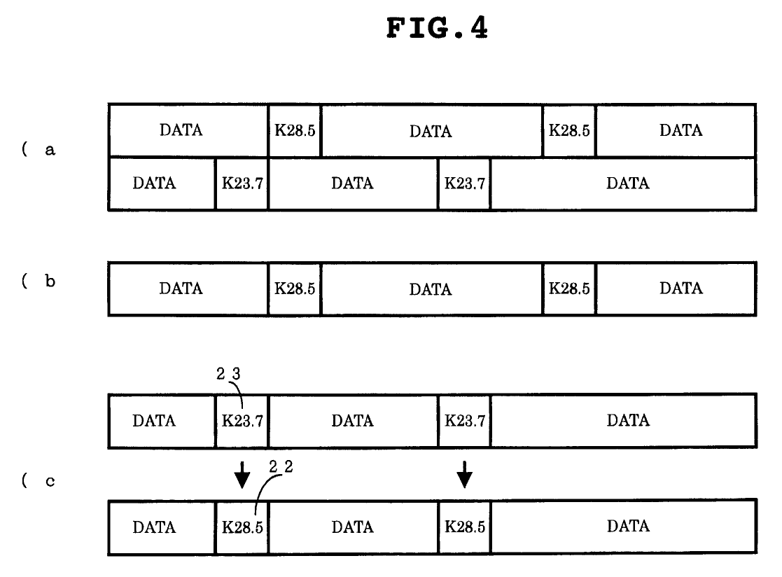

On reception, the code swapper 17 converts the K23.7 signals 23 to the K28.5 signals 22, as shown in FIG. 4(c). Here, FIG. 4 shows the following three data constructions in order. FIG. 4(a) shows the signal received from the 20-bit series-parallel converter 18. FIG. 4(b) shows the high-order 10 bits of the received signal. FIG. 4(c) shows the low-order 10 bits of the received signal, before and after the code swapper 17 converts the K23.7 signals 23 to the K28.5 signals 22.

While the preferred embodiment takes the example of a Gigabit Ethernet, it is obvious that the present invention can be applied to other signals employing 8B/10B encoding, as in fiber channel technology. Further, while the preferred embodiment describes multiplexing two Gigabit Ethernet signals, the present invention can be used to multiplex three or more Gigabit Ethernet signals by substituting an other K code for the word alignment code for all signals except the signal inputted into the high-order bits of the series-parallel converter.

### INDUSTRIAL APPLICABILITY OF THE INVENTION

According to the present invention, signals using the 8B/10B code such as Gigabit Ethernet signals can be multiplexed with a series-parallel converter.

What is claimed is:

1. A multiplexer that multiplexes a plurality of signal streams encoded according to an 8B/10B encoding scheme, the multiplexer comprising mechanisms of:
preserving word alignment codes in one signal stream of said plurality of signal streams;
converting word alignment codes in all other signal streams of the plurality of signal steams to different codes; and, transmitting a resulting multiplexed signal.

2. A multiplexer as recited in claim 1, wherein the word alignment codes are K28.5 codes.

3. A multiplexer as recited in claim 1, further comprising an elastic smoother.

4. A demultiplexer for use with a multiplexer that multiplexes a plurality of signal streams encoded according to an 8B/10B encoding scheme, the multiplexer having mechanisms of preserving word alignment codes in one signal stream of said plurality of signal streams; converting word alignment codes in all other signal streams of the plurality of signal steams to different codes; and, transmitting a resulting multiplexed signal, the demultiplexer comprising mechanisms of:
receiving a multiplexed signal from the multiplexer; and,
converting the different codes back to original word alignment codes while dumultiplexing the multiplexed signal thus received.

5. A muletiplexer as recited in claim 4, wherein the different codes are K23.7 codes.

6. A multiplexer/demultiplexer comprising:
a multiplexer unit that multiplexes a plurality of signal streams encoded according to an 8B/10B encoding scheme, the multiplexer unit comprising mechanisms of preserving word alignment codes in one signal stream of said plurality of signal streams, converting word alignment codes in all other signal streams of the plurality of signal steams to different codes, and, transmitting a resulting multiplexed signal; and,
a demultiplexer unit comprising mechanisms of receiving a multiplexed signal from a multiplexer unit of another multiplexer/demultiplexer, and, converting the different codes back to original word alignment codes while dumultiplexing the multiplexed signal thus received.
